(19) United States
(12) Patent Application Publication
(10) Pub. No.: US 2015/0039343 A1
(43) Pub. Date: Feb. 5, 2015

(54) SYSTEM FOR IDENTIFYING AND LINKING CARE OPPORTUNITIES AND CARE PLANS DIRECTLY TO HEALTH RECORDS

(71) Applicant: Lightbeam Health Solutions, LLC, Irving, TX (US)

(72) Inventors: Patrick Cline, Irving, TX (US); Jerry Schultz, Irving, TX (US); Robert Nary, Irving, TX (US); Jibu George, Irving, TX (US); Michael Hoxster, Irving, TX (US)

(21) Appl. No.: 14/449,098

(22) Filed: Jul. 31, 2014

Related U.S. Application Data
(60) Provisional application No. 61/860,509, filed on Jul. 31, 2013.

(51) Int. Cl. G06F 19/00

(52) U.S. Cl. CPC G06F 19/3431; G06F 19/363
USPC 705/3

(57) ABSTRACT

A method and system for improving care and reducing adverse events and cost by identifying patent care opportunities and integrating them directly into electronic hospital records and the provider's routine workflow. The invention enables clinicians, care managers and users to improve care and efficiency by assembling data from disparate sources, identifying care opportunities and integrating them directly into the EHR system and their routine workflow, while tracking that the recommended action was taken.

### BACKGROUND ART

1. Field of the Invention

The invention relates to population management, analytics and electronic health records. More particularly, the invention relates to a method for optimizing health care delivery with the use of electronic medical records.

2. Description of the Related Art

Health systems, payers and provider organizations that utilize electronic systems for tracking health records, and especially those involved in risk or quality-based reimbursement, do not have a solution that provides a complete view of the patients they serve. They cannot automatically and cost effectively gather and connect patient data from their system with data from across the healthcare community, organize it into a consumable format, compare it against their own personal or nationally recognized guidelines, identify gaps and intervention opportunities, and notify the provider by creating a task in their routine workflow. A task that is linked to a clinical patient summary that includes a complete record and highlights the care gap or opportunity includes histories and specific care instructions for that patient. Today, there is not an effective and efficient method for assembling, linking, removing duplicate entries (“de-duping”) and normalizing patient information from multiple sources, identifying and reporting gaps in care directly into an electronic tasking system from their native workflow.

This tool will help them to proactively improve the overall quality of the population serve and reduce avoidable costs associated with care managers manually gathering and handling this information as well as avoidable emergency room (ER) and hospital visits.

### SUMMARY OF THE INVENTION

The invention is a system that links the caregiver directly to the person or populations needing attention, highlighting exactly what needs to be done and auditing the results. The invention creates tasks and actionable information directly in the caregiver's native workflow allowing them to import the clinical information directly into their electronic health reports (EHRs) to place orders and document care recommendations.

The system helps providers, insurers and risk-bearing organizations improve quality, reduce preventable adverse events and costs by:

collecting and combining claims and discrete clinical, personal, social and biometric data from multiple sources including their EHRs;

organizing information into a single de-duped/normalized patient record or clinical patient summary;

comparing that information against clinical guidelines, these guidelines can either be preloaded into our system or custom guidelines created with our proprietary rules builder;

identifying gaps in care or care opportunities;

creating a custom care plan for the patient;

pushing that care plan directly to the responsible party (payer care manager, physician's care managers/nursing staff, etc); and

leveraging analytics tools that track and report compliance, cost and quality scores (PQRS, HEDIS, STAR, etc).

Patient data is gathered from multiple sources including, but not limited to, EHRs, health information exchanges (HIEs), payers, hospital systems, claims data, prescription data from pharmacies and pharmacy benefit management (PBMs), labs and patient biometric monitoring devices, financial records, credit scoring agencies, genomic databases and search engines. The data is then linked by a Master Patient Index (MPI), mapped to a healthcare data model, cleaned, de-duped, normalized to create a complete chart, or Clinical Patient Summary.

Once organized into a consumable format, a clinical guideline/rules engine allows users to compare this data to the latest up-to-date care guidelines or their own rules. A comprehensive and intuitive clinical rules builder allows customers to build their own custom care plans/guidelines/protocols/pathways.

The complete patient record contained in the system is then compared against those guidelines. Treatment opportunities or gaps in care are identified and the system then creates a care plan as well as a task. The system also assigns an acuity or priority to that task for that patient. The task is written directly into the EHR tasking system (Workflow Module) and contains a link to a care plan containing specific information to that patient's history and reason for intervention. The task is pushed directly into the EHR and contains a link to the care plan that is stored on our web-based applications and access via secure cloud-based technology. The care plan contains a complete record of the patient's treatment history along with the care gap (or treatment opportunity). The provider can view the care plan and press a single button to accept the care plan recommendations, orders, order sets. The invention can be configured in a number of ways. In other embodiments, the invention can be configured to automatically update the EHR of the provider and notify the provider the information is present in the EHR. They are then automatically recorded and stored in directly into the EHR system and copied back to an electronic data warehouse (EDW). Each opportunity is tracked until completed and alerts when tasks have failed to complete.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a workflow diagram with an illustrative embodiment of the invention including data integration services, data from an EHR combined with information from other sources in an EDW and then being compared to guidelines in the Rule Builder, the Rule Warehouse, The Rules Engine, the Care Management, Analytics and Utilization Management Systems, and External Rules Sources and External Care Management Systems.

FIG. 2 is a representation of additional functionality of the rules engine, more specifically the part that manages Care Plans and Tasking as well as the embodiment of the invention that manages Site Profiles to facilitate communications.

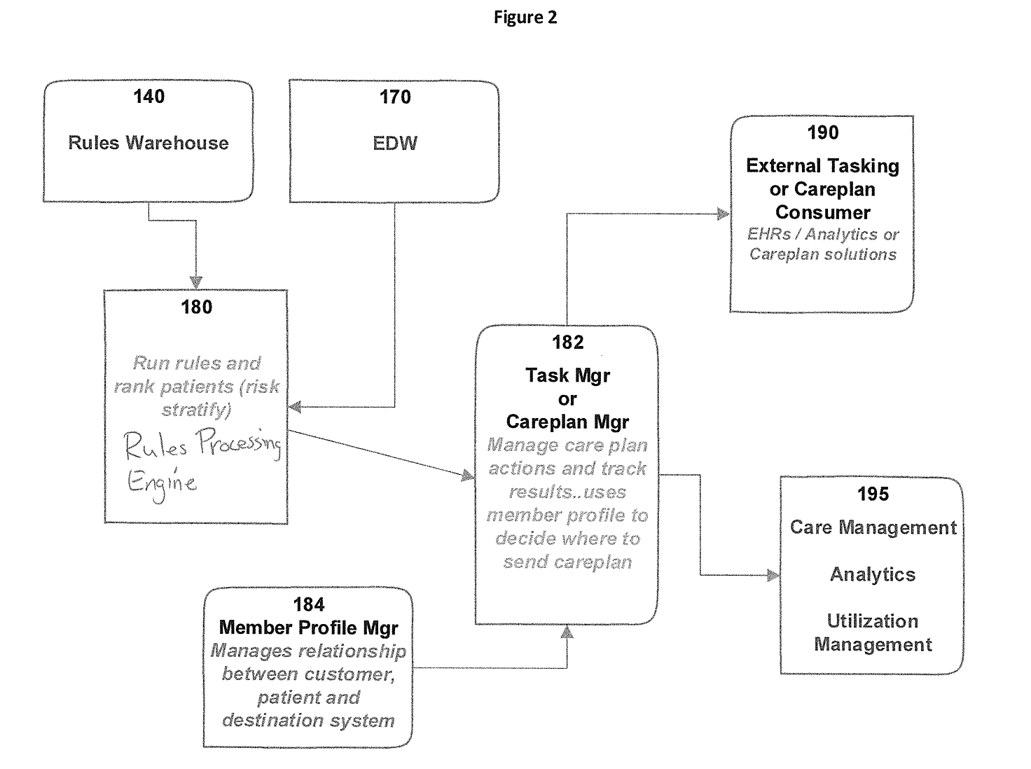

FIG. 3 illustrates additional detail around rule management and the rules warehouse.

FIG. 4 is a workflow diagram of care plans and tasks being created and transmitted to the Provider Systems and illustrates how rules are connected to tasks and how tasks are connected to care plans and how tasks and care plans are connected to external systems, portals or Partner Systems.

### DETAILED DESCRIPTION OF THE PREFERRED EMBODIMENT

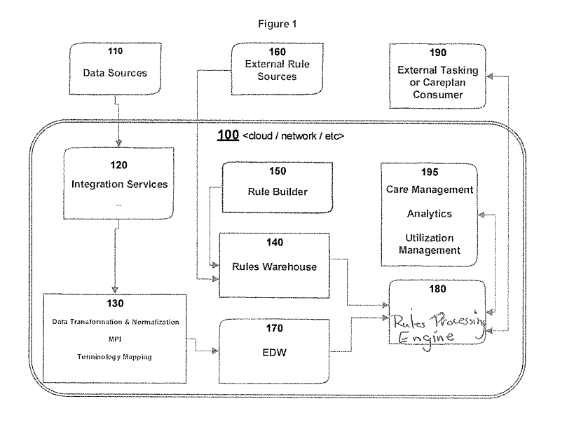

FIG. 1 represents a healthcare data ecosystem 100 configured to gather broad and discrete data on a real time basis from multiple disparate data sources 110. All data that upon observation could be related to or a factor in deciding the appropriateness of care for that patient will be assembled into a consumable format. The Integrations Services 120, Data Transformation, Normalization, MPI, Mapping 130, Rules Building 150 and Rules Warehouse 140, Electronic Data Warehouse 170, Rules Processing Engine 180, Care Management and Utilization Management 195 and Analytics 195 are performed in by our invention on our servers and made available via a cloud, web, TCP/IP, VPN and other types of connections. Data Sources 110, External Rule Sources 160 and External Tasking 190 represent third party data sources that are transformed into the invention for consumption, or third party applications that will consume this inventions output.

Discrete data is gathered from multiple sources 110 including but not limited to ambulatory systems, inpatient systems, health information exchanges (HIEs), payers, care management systems, hospital systems, claims data, prescription data from pharmacies, pharmacy aggregators and PBMs, labs, patient biometric monitoring devices, credit score agencies, genomic databases and sources and search engines. The inventions ability to support real time exchange of data is a significant factor in providing accurate and timely population, payer, patient and provider related analytics, notifications and tracking.

The Integration services layer 120 provides the transport infrastructure and supports current and future standards based interfaces such as HL7, CCD, CCR, XML, claims, and where applicable the Integrating the Healthcare Enterprise® (IHE) profiles used to integrate such as xdr, xds.b etc. It also supports custom interfaces, capable of reaching directly into source systems to extract data.

Data transformation and normalization 130 facilitates the mapping of data from disparate data sources using various terminology, codes and abbreviations into a normalized data set within the enterprise data warehouse (EDW) 170. The normalization will facilitate the execution of analytics on the dataset as a whole and provides a more complete and comprehensive view of patients and populations, as well as providers and payers. The data is linked by a Master Patient Index (MPI) 130, cleaned, and mapped to a healthcare data model in the data warehouse 170 to create a complete chart, referred to hereinafter as a clinical patient summary.

Site Data Links and Care Communication Link Tables will be maintained in a Site Profile Manager 184; it creates maps that link providers, patients, payers to their sources and each other, even when they were not connected by a specific transaction or data source. The system stores the source of each data stream and relevant caregivers, payers, locations of service and providers in that system to enable linking them from a communication, tasking, care plan delivery and monitoring standpoint. Some of these sources include but are not limited to inpatient systems, ambulatory systems, patient owned devices, HIEs, PBMs, Prescription Aggregators, pharmacies, labs and payer systems. A key factor in the system will be the retrieval of Communication link data related to care givers, care managers, providers, including Primary Care, Specialist, Nurse as well as Family Members hospitals, plans, or other individuals involved in the “Care Team” of a patient.

Site data links are used to provide cross reference links between external systems with related data, for example a provider in two systems could be referenced in their native systems with different identifications (IDs) yet are the same for purposes of tracking and associating data and coordinating care. The site data links provide the details on source system and will be used to facilitate communications back to the providers in their routine workflow. It will provide a number of critical services such as identifying when data is redundant, creating a complete picture of the providers involved in caring for a patient, understanding what type of information needs to be pushed back to the providers and to what providers the data should be pushed. It will include, but not be limited to linking the individual IDs for each provider and patient from each external data sources. By way of example, patient data is collected from an ambulatory EHR that indicates a provider ID and name. Data is then collected from a hospital system with a different name for the provider such as Robert vs. Bob, as well as additional data for the same patient. The provider and patient data has different ID numbers from their various external data sources but Site Data Links correctly identifies that they are the same provider and patient using a couple of data sets that typically do not change (e.g., social security number), identifies and de-dupes redundant information, normalizes the data and creates a unified normalized data set from the disparate data and/or disparate systems. It also stores a complete record of the original source data from each external data source and what source system the provider used. The Site Data Links utilizes deterministic and probabilistic models to identify when redundant information exists and when it should be consolidated into a unified clinical patient summary (a normalized data set).

Evaluation of Prebuilt Rules is performed by rules engine 180. The system will facilitate the evaluation of rules for single chronic disease states such as Diabetes, COPD, and CHF or for multiple co-morbidities as well as rules designed to highlight financial, preventive and wellness screenings or other types of gaps. These rules are typically available in text format and are not linked electronically with EDWs, EHRs and Care Management systems to be evaluated and acted on. The invention solves this problem by organizing them into pre-populated rules that are linked to and evaluate specific logical elements contained in the EDW 170. Rules create actions based on a user applying conditional logical expressions to data elements in the EDW. The invention allows a user with the appropriate permission to create, access, utilize or even modify pre-built rules 140. The rules are made available to end users in either a hosted or cloud environment or downloaded and imported into their environment.

The Rules Builder 150: A unique aspect of the essence of this invention is that it allows users to create rules 150, 160 that are designed to identify people, populations, providers, payers, care gaps, cost variances, quality variances, cost and quality trends, etc. without having to know the underlying complexity of the data schema in the EDW 170 or how to use a programming language. The rules builder 150 represents the data elements logically in terms that users of the rules builder 150 will be able to relate to, because of their background in healthcare, and abstracts the physical aspects of the database making it easy for subject matter experts (SMEs) to support rule building. Thereby reducing, or altogether eliminating, the number of people these SME's need to interact with when modifying or adding a new rule. This type of “Rule Management” should reduce the barrier to entry for clinical SME's that currently have the knowledge to construct rules but frequently are hampered by the cumbersome process to get rule sets built with the products available in the market that require programmers, data modelers, business analysts, DBA's and the SME all to be involved in the process of constructing rules today. The rules builder 150 eliminates the need to have programmers write programs to contrast the queries that would accomplish the same search as that provided by the rules builder 150.

The rules builder 150 supports a robust set of data points from the EDW 170 that represent normalized data collected from 110 by Integration Services 120 and organized into a format 130 consumable by the rules engine 180 executing the rules stores in 140. The Warehouse schema, contained in EDW 170 will be leveraged to facilitate data storage from across healthcare and non-healthcare data sources 110. Data sources will include but not be limited to Inpatient Systems, Ambulatory Systems, Medical Devices, Smart Phones, Urgent Cares, Pharmacies, labs, prescription aggregators, financial services, search engines, genomic databases and claims sources as well as additional types of information previously mentioned herein, or not reference in this document.

Rules that are pre-loaded in the rule warehouse 140 can be shared with and accessed by users through the cloud and accessed by a browser, the web, or integrated into third party applications 190. This is a particularly useful aspect of the invention as it allows users to avoid the cost, labor and complexity of building and maintaining rules. The invention allows a new customer 110 to connect 120 to their data into the EDW 170 and benefit from the utilization of existing rules 140. It's important to note that the rules used to manage healthcare's clinical and financial metrics are constantly changing, and therefore need to and can be modified by users. Pressure to reduce cost and improve quality is growing. These pressures are driving new reimbursement models, treatments, clinical protocols, wellness, immunization and prevention guidelines, new government initiatives, and quality measures. Quality improvement organizations as well as payers and provider wishing to improve their own cost, utilization and quality measures are increasingly searching for ways to track patient and personal compliance with actionable data in the real-time to identify care, quality and cost gaps. There are many more examples including simply wanting to identify patients and populations in need of a health risk assessment, with missing or incomplete information, a change in social status or adding fields like “lives alone” or “driving status” to a rule that's operates a diabetic measure. Therefore, the invention allows rules to be loaded into the rule warehouse that are either; a) built by a user with inventions rules builder 150, or b) assembled by External Rule Source tool 160, or c) modify and save existing rules. These rules are stored in the rules warehouse 140 and organized into a consumable format that allows them to be compared to specific logical data elements stored in EDW 170. The rules builder 150 and rules warehouse 160 are accessible via as a hosted, web or desktop application.

The rules builder 150 is used to create rules, based upon combinations of logical data elements that can include any data field contained in the EDW 170 including but not limited to types of data elements and types of data. Data that by example could include numeric values, text, clinical, financial, social, medical economic values, data represented by and including standardized nomenclature. The rules builder 150 allows a user to create conditional expressions based on logical data elements that are stored in EDW 170. These logical data fields can be added to existing rules or onto a completely new rule using the rules builder tool 150. The user can attach a conditional expression to any data element that the system will use to identify information that needs to be reported or acted on. This conditional expression acts as a trigger. Information that could be included, but is not limited to financial or clinical gaps, financial or clinical trends, patients, populations, providers and quality gaps. By way of example, the EDW contains logical data elements that represent and store a patient's blood pressure and medications. The rules builder 150 allows a user to browse through available fields contained in the EDW. To speed selection the EDW fields will be grouped to facilitate easier selection. Once the user selects the field used to store a patient's blood pressure they then place that field into the expression used to define a new rule. The rule can also include other fields such as age, weight, body mass index, etc. The user can then attach a conditional expression to blood pressure field like “greater than” and instruct the system to create a rule that identifies all patients with a blood pressure>120/80. Additional fields can also be added and include conditional expressions so that a user can develop a specific rule that identifies patients with blood pressure over 120/80 who are also >50 years old and have not had a prescription for a class of blood pressure lowering medications within the past 6 months. Or for diabetic patients, who are over a certain age and have not had a foot or eye exam within the past 12 months or had a HAlc.

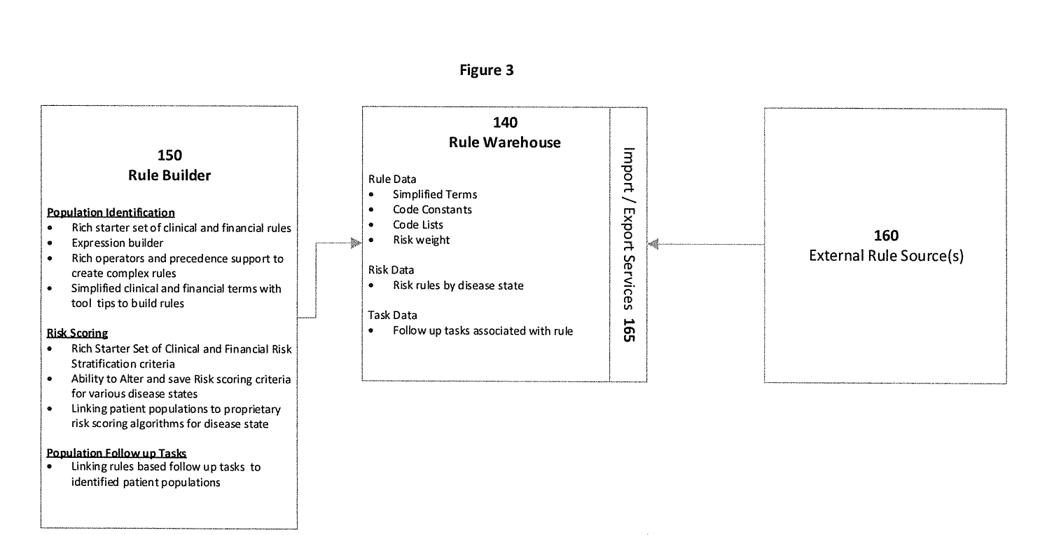

External Rule Sources 160 and Rules Builder 150 allows for a user to take the guidelines provided from reference sources, and often contained is a text file, pdf, spreadsheet, HTML form and quickly create electronic rules with actionable tasks attached to each. These rules while available in text format are typically not linked electronically into the system to be evaluated and acted on as patient/provide/payer related events occur. Rule importing provides the ability to import rules from third party guidelines and content vendors as well as, but not limited to the governments website, universities, pharmacies, government agencies, quality improvement organizations, research organizations, customers and users of the product, payers, provider organization, pharmaceutical companies, compound pharmacies, care management organizations, clinical measures programs, laboratories, etc. The invention allows for the transformation of guideline content from various sources to be converting into electronically executable content. The ability to bring in rules from third party sources, based on established or agreed specifications and terminologies, can be automatically loaded into rules warehouse 140 using the External Rules Sources tool 160. Where agreed upon or existing specifications, nomenclature and terminologies exist; the resulting rule will be associated with, cross references and mapped to corresponding fields and specific data contained into EDW. A standard API or standard format 165 (FIG. 3) is an import/export services layer used by the third party content providers to publish and output their updated guidelines into a format that can automatically be uploaded by external rules source 160 and stores in rule warehouse 140.

By way of examples, rules created by either the Rules Builder 150 or External Rule Sources tool 160 will be designed to evaluate and identify patients or populations for single chronic disease states, such as, but limited to Diabetes, COPD, and CHF or for multiple co-morbidities. These rules will also be able to identify patients, populations and providers and payers with overdue, pending events, incomplete data, or quality measures. Rules can also identify patients, providers and payers that have patients and populations with data that needs to be acted on such as annual HRAs, wellness and preventive screenings, identifying risk factors, identifying and reporting compliant and non-compliance with quality measures, identifying both over and under cost utilizations, comparing cost, utilization and quality measures against benchmarks and reporting aberrations or outliers. Identifying patient and providers whose actions, or lack thereof, are leading to avoidable or preventable costs. The system facilitates the creation of rules that identify patients and populations with; care or financial gaps, clinical or financial trends or variances, or in need of care or medical management. Additional examples could include managing the treatment of populations, as the output of rules will be patient populations identified as treatment opportunities based on aforementioned criteria or formatted to support measure programs. These may be standard and outlined by CMS such as PQRS, HEDIS, ACO or Stars, or custom rules built to identify patient populations in need of treatment. The output will also include all associated providers and payers as well as any associated information contained in the Member Profile Manager 184, Site Data Links 184.

The rules builder 150 and External Rule Sources 160 also allow a user to attach a ranking, assign an acuity level, or risk stratification level within each rule. The rules builder 150, 160 allows users to assign a value that depicts higher levels of acuity, ranking or risk to support the risk stratification of patient(s), populations, payers and providers identified by the rule. This allows users to sort, filter, list, view, highlight, stratify or rank patients who are in need of care and the providers or payers responsible for that care, and identifies or flags items that are of an urgent nature. Rules contained in the rule warehouse 140 and accessible to users of care management and analytics 195, or to users via integration with their third party application 190, the cloud or web-based applications include a risk stratification, ranking or acuity level. The rules builder 150 includes built in stratification criteria that are based on factors such as disease risk, potential harm to the patient, potential financial impact to providers/payers, previous cost, likelihood of readmission, risk of additional adverse events, risk to the patient, potential future cost, cost avoidance, ability to have a favorable cost of quality improvement or additional user definable criteria. Stratification, or ranking or acuity criterion that is published in the medical industry is also considered. These canned set of stratification criteria that are based on individual diseases or related to multiple co-morbidities will be available as a rule in the system. Users, with the appropriate authority and permission levels will have the ability to modify, adjust or personalize risk stratification, acuity or rank 150. This risk stratification is a crucial part of identifying the smaller subset of a very large population that may be trending towards critical health issues and allowing caregivers to focus on this subset to provide better care and reduce the financial impacts of these patients on the system. The risk stratification method matches data on patients against the rules to determine where on a relative scale a particular patient falls. If the patient has a higher risk, directing more resources to that patient may better assist that patient than one that has a lower risk. The risk stratification method may change the allocation of resources and is describing in copending patent application 61/993,444, filed on May 15, 2014, and is expressly incorporated herein by reference. This will also allow the system to identify patients that may not be at a high enough acuity to warrant Care Management and facilitate Patient Education and less intense care management being done by the provider's offices and care givers to ensure that they do not get to a critical stage. And for trending, aggregation and accumulation of individual ranking, risk and acuity scores for patients to then be measured, tracked and reported by individual providers, groups of providers, provider organizations, health systems, care managers, groups of care managers, payers or any subsets of plans and programs within those payers and provider organizations.

By way of example; the system will address a critical factor of risk stratifying patient(s), providers, payers and population rankings, apart from determining which patients are in need of an intervention or evaluation (Treatment Opportunities), based on factors such as, but not limited to single or multiple disease combinations, HCC Code(s), a patients social history, family history, medical history, economic data points, credit scores, search engine activity, prior charges, their velocity and frequency of care, ADL scores, information gathered from HRAs, admissions or discharges from hospitals, current medications, a change in medical status, a change in social or marital status, a change in social status, medication compliance, complexity of medication compliance, exercise and activities, risk behaviors, drug to drug interactions, addictions, alcoholic intake, family support, lives alone, individual and specific diseases, co-morbidities, depression and behavioral health disorders, age, BMI, recent admission or discharge from care, participation is a specific quality improvement initiative, genomic data or any other field in the EDW 170. Apart from the aforementioned examples, the results of this risk stratification will be prioritized lists of patients that payers, providers and health care entities can use to target the patients with the highest potential for positive results and cost avoidance. Or to target the providers or responsible parties based on the accumulative or average risk scores for the populations assigned to that provider, payer or care manager. The invention allows a user to evaluate and track the total risk scores and risk trends for an individual person, population, payer, provider or providers, or any program that stands to benefits from such risk measurement.

The rules builder 150 also allows users to associate goals, or ideal outcomes within the electronic care plans with each rule. Or, said another way, each rule stored in the rules warehouse 140 contains instructions that it will use to direct the external tasking and careplan consumer 190—care management 195 the recipient as to the goal and the type of care or action 182 the person is in need of The system will also facilitate the linking of this risk stratified patient pool individually or in mass to a closed loop care plan that is comprised of workflows, tasks and a specific care plan related to complete care of the patient by all related care team members, or activity that a provider, care manager or payer needs to perform on a group or population when a rule interrogates the patient's data and receives a positive match. Meaning, when the information contained in the patient(s) chart matches the conditional expression it launches a message to 182 and flags that patient record with the acuity/risk score and specific action needed to be taken. Those messages will be processed by the communications manager 182 or 184 and are discussed in detail as follows. Components of the care plan will include typical treatment guidelines, treatment goals and specific instructions, order sets and other types of recommended activities for patients with a need for intervention, preventive or wellness screening. It will build upon these electronic guidelines by linking the tasks to be performed by various members of the care team into groups and setting up tasks for each item and the responsible member of the care team. In addition to the Guidelines for treatment the System will support the modification of these “Care Plan Templates” by users to facilitate special conditions and goals that they may want to factor into the care of patients and populations. When a rule encounters a positive match for a patient, provider or payer it creates a transaction or message in Care Plan and Tasking Manager 182 and 201. Leveraging Site Maps 184 and Partner Care Plan Profile tool 202, meta data as well as additional data sources the system generates an outbound message 204 that writes a task in the tasking or workflow module used by the provider or care manager in their native environment 206.

Care Plan Integration with a native Partner System 206, that is also possibly also a Data Source 110, is a key attribute of this invention. The system will facilitate the linkage of these care plans into the systems used to document care, often referred to as EHRs for a given provider or care manager. This integration will be directly to the system of record, stored in the Site Data Map 184 that providers, or other users, use 206 to facilitate seamless access to the data of the care plan and will leverage open api's 207 available from most of the significant electronic medical record (EMR) vendors, examples of systems that provide rich integration capabilities are Epic, eCW, Cerner, Greenway, Allscripts and NextGen. The system 204 also facilitates; integration into the tasking and messaging capabilities of these systems 206 and linkage of a personalized care plan, 201 and 202. Using the vendors integration profile available to external entities and bases on the information stored in 184 and 202 the invention knows the type of system the care plan is being delivered to and tailors the care plan components 201 and 202 to a format that's compatible with and native that system. Information such as order sets, goals, patient education materials, personal information, care plans, specific test or interventions, and other types up updated medical information will be made available to be linked and/or directly imported into the system 206 native format and workflow. The system will also facilitate the transmission of care plan related activity back to the Care System to ensure compliance or Non Compliance of the recommended Care Activity. Where API's, standards or support from vendor systems (206) does not exist the Client Agent 204 will create a task or message and imbed it directly into Partner System 206 using Partner API Tool 207. The imbedded task, message or notification will be completely compatible with and treated the same as a task, message or notification that would be created by the Native System.

Tasking and Tracking: The system 182 provides rich tasking support for any items relevant to overall “Care Workflow.” Tasks and their corresponding care plans are tailored for any type of disease, preventive/wellness screening and are specific to each patient, provider and system 206. One component of this workflow will be the system-generated tasks and another component includes the corresponding care plan that the task links to. Tasks are linked to a form on inventions server 201 that includes a care plan, treatment guidelines, stated goals, histories, risk score, other risk factors, medications, third party interventions, etc. Any information contained in EDW 170 can be drawn upon and incorporated onto that form. Each form also contains the necessary components that are specific to partner systems 206 and will be used to incorporate that information directly into those systems 206. The tasks are also weighted (acuity, risk score) to notate the impact of noncompliance or completion and specified timeframes that are relevant to the patients overall health status. By way of example, the following illustrates some types of tasks that need to occur for a patient with diabetes.

Provider Office→Schedule Office Visits that are quarterly and Yearly, including reason why—foot exam, eye exam, vascular study, etc.

Provider Office→Provide Patient Education Material related to Physical Activity and weight loss

Provider Office→Issue Prescription, evaluate compliance and record Non Compliance during visits for Physical Activity, Diet, Medication Compliance

Provider Office→Order Lab Tests, evaluate results and record them

Provider Office→Evaluate Patient and report progress, rules are included to detect if something like blood sugar is trending poorly and the system could then generate a task in the provider office system and notify them of such.

Patient→Maintain a Level of Physical Activity

Patient→Take Medication

Patient→Provide recent blood sugar levels

Patient→Comply with recommended Diet

Patient Family→Copy any or all Provider Office or Patient messages to one or more care givers, guarantors or family members.

Tasks, including the aforementioned acuity levels, reason, patient, care plan, follow-up date will also be reported to inventions Care Management module 195. All of the information contained in the EDW 170 for that patient will be accessible to users of 195 and linked directly to the patient and the task. Completion of these tasks and attainment of goals will be tracked 195 for compliance and reporting purposes 195. The inventions analytics capabilities 195 can also format this information for consumption by External Systems 190. The frequency of reminders, the recipient and the priority of tasks will be linked to the acuity or risk level of a given task as well as the number of attempts made without a response. By way of example, if a medication-to-medication interaction indicates a high risk of serious injury, the system will indicate a higher acuity/risk and then escalates the urgency further by copying care managers, supervisors, the patient, additional providers, other user, family members (using the information contained in the member profile manager 184) if there is no initial response. It can also track and trend non compliance for non-urgent matters such as; lack of diet control for obese and pre-diabetic patients that could lead to a diabetics health state and a deteriorating/costly condition. The analytics platform 195 tracks compliance and longer term trends to show providers and payers that specific factor(s) indicates patient or population are trending towards the next level of the disease, so that the appropriate intervention can then be identified by a rule stored in the rules warehouse 140 and performed by the analytics system 180. Another significant component of the system will be “Alerts” and “Tasks” that relate to a change in patient status such as moving from one stage of a disease to another as a result of non-compliance or other factors such as readings from home monitors or biometric devices.

The systems analytics platform 195 tracks and associates the impact of task compliance and non-compliance to the patients and populations overall health status and risk score. The analytics model 195 is also tracks and trend risk scores, quality scores, quality metrics, goals achieved by patient, population, payers, care managers, care coordinators, providers or groups of providers. Over time these tasks will be tracked 195 to develop a profile of compliance and risk scores for patients, population's, members of a care team, and relevant persons or entities notified of “performance” as it pertains to a pool of patients in a providers case, or the patient themselves. Risk scores are also tracked and trended over time and reportable by the aforementioned categories.

The performance reporting 195 tied to the provider, payer, patient or population for risk, compliance and better health status also is used to track rewards, compliance and bonuses for individuals, care managers, patients, payers and providers. Rewards and penalties currently include, but are not limited to, government rating systems such as STAR ratings, HEDIS, ACO Measures, shared saving pools, gain share arrangements and other forms of quality or cost based bonus metrics. The invention 195 also allows for the grouping of information so that a supervisor can track, trend, report and compare metrics like risk scores and tasks completed for their patients and populations thereby allowing the supervisor to truly measure the effectiveness of the interventions and of care managers, providers, quality improvement initiatives, etc. Today, there is not an effective way to track and compare their initiatives, workloads, cost savings, quality improvements and staff efficiency against one another. For patients and populations the rewards include better health as well as, for example, inclusion in a commercial program that awards points to the patient each time they submit their required information either by texting, the web, a biometric device, IVR or speaking directly to the care manager. Information could include blood pressure, blood sugar, and peak flow rate, and pulse oxygen, validation that they took their medications or exercised.

Care Plans 201 can be disease based, preventive in nature or linked to an entire population and tasked to external source systems 206 when actions need to take plan. For example, the system identifies multiple patient overdue for a procedure, lab, medication refill or wellness/preventive screening and generates a list with each person identifies in that list. As shown in 182, the System supports a standard set of Care Plans that outline the Plan Details as shown in 201. These plan details include details such as, but not limited to, the name of the care plan, the goal, associated disease state, the original source, and the criteria for the patient to be eligible for the Care Plan. By way of example, the criteria that determine a patient's eligibility in a care plan could be associated with them being in the top 3 percent of the risk stratified patient pool associated with one or more patient identification rules 140 that are part of the base rule/measure set.

The care plan will also include the general “Plan Workflow” as show in Item 201b (not to be confused with a simple task list). This Plan 201 and workflow will encompass the following;

Standard Guideline Tasks: related to Standard Treatment Guidelines as shown in 201b.1. An example of a task related to a basic diabetic care guideline might be the scheduling of a quarterly office visit.

Customized Guideline Tasks: The plan supports Customer modified guideline tasks as shown in item 201b.2

Non Guideline Tasks: The system also supports tasks that may be part of a workflow but not necessarily associated with the “Clinical Guideline” shown in figure 201b.3 but necessary for the workflow overall such as the authorization for Referrals, Tests, etc.

Each of these disease, action specific or care plan tasks, or goals, will be associated with a specific role in the patients care team using Site Profile Manager 184 including, but not limited to, the Provider, Primary Care Provider, Cardiologist, Podiatrist, Internist, Ophthalmologist, Urologist, Pulmonologist, Admitting Provider, Discharge Provider, Surgeon, Oncologist, Endocrinologist, Nurse, Patient, Patient Care Taker, Care Manager, Care Coordinator, Social Worker, Transition of Care Team, Home Health Worker, Family Members. As mentioned above, each associates task and care plan sent to each role includes a standard time for the completion of the task or follow-up on the task. Site Profile Manager 184 also stores each care team members preferred method of commination. If a care team member utilizes a Partner System 206, the Client Agent 204 will transmit the task to that system along with the necessary components to imbed that task and care plan into that system. If the patient, family member or person is not using a Partner System, the system will store a profile 184 and 202 listing their communication preference. Preferences could include Portal 205, their External System 190, 195, texting, Smartphones, IVR, browser, phone, onsite visit by social/care worker, etc.

Prebuilt Care Plans are stored in the system 182, 201 as default care plans and associated with specific rules, goals, financial or clinical guidelines or disease states such as Diabetes, COPD, and CHF etc. Any of these prebuilt or default can plans can be modified by users with the appropriate permission using Care Plan manager 182.

Partner Care Plan Profile

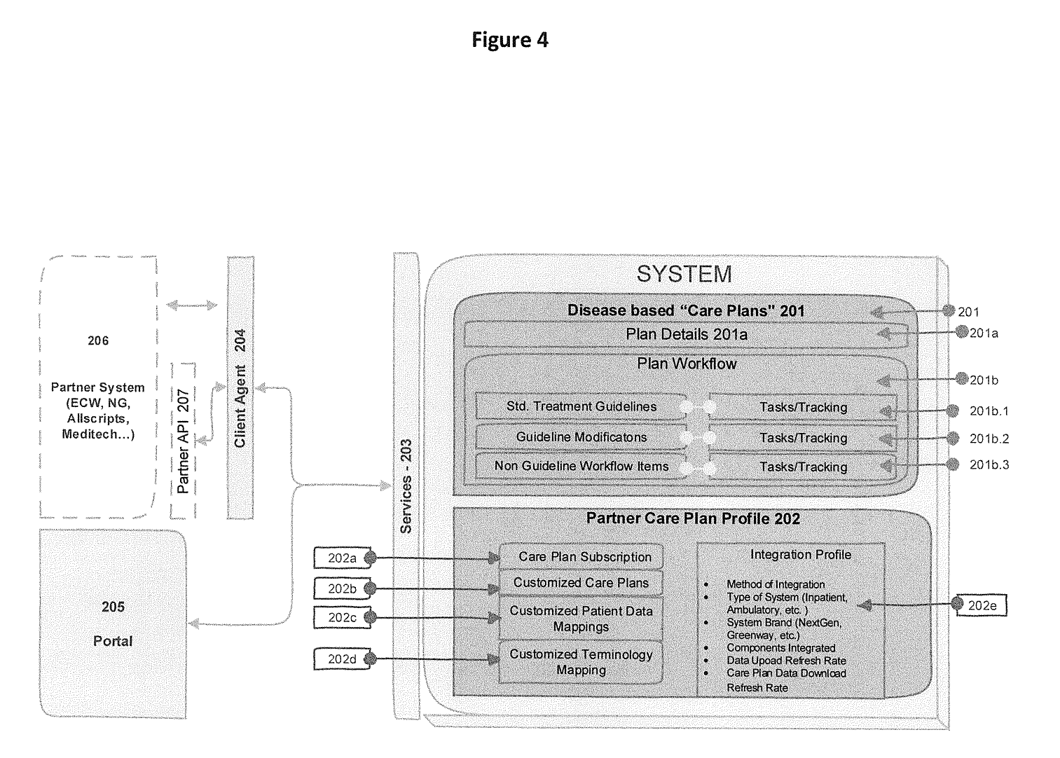

Partner Registration Portal 205 allows an integrating system, wishing to connect to the invention to register through Portal 205 (FIG. 4). During registration basic information will be collected as describes in 202e to facilitate the Client systems registration. Once known, Partner Systems 206 with previously identified methods of integration and established tasking/messaging/communication routines will connect through Client Agent 204. Most of the leading Inpatient and Outpatient EHRs and Care Management System are Known Partner Systems and communications are already established.

The invention will use the information obtained from Portal 205 to determine which API to assign to that new system. The invention will build and maintain Partner Care Plan Profiles as further described below;

Partner Care Plan Profile 202 maintains a communication profile, or API, for each Partner System 206. Once registered by Portal 205, or recognized as an existing Known Partner 206, partners will be able to link their system to the system via the Client Agent identified in item 204.

Integration Profile (Item 202e): The integration profile for a given client entails the unique aspects of the Partner System 206 and the method of integration. Some of these items will be discovered by the system install process for the system client agent (204), and some will be input into the system by Portal 205, where the element cannot be automatically detected by the invention. The items that will be stored by the system will facilitate seamless integration with the Partner System 206 and customize content and optimize the data being delivered to the system based on each profile, these items will include:

Method of Integration 202e which outlines the use of Browser based components for integration or rich API based integration. This also specifies what interfaces (standards based or custom) are used to integrate such as HL7, CCD, CCR and where applicable the IHE profiles used to integrate such as xdr, xds.b etc Each profile will some of the following information used to integrate tasking, and care plans directly into the providers native EHR and workflow.

Type of System: (202e) Inpatient, Ambulatory, Care Management, etc.

System Brand: (202e) NextGen, Greenway, Allscripts Epic, Meditech, Siemens, etc.

Components (202e) integrated such as Tasking, Integrated Care Summary (CCD), Discrete Care Plan or Document based Care Plan

Data Upload Refresh Rate: (202e) The rate (Real-time, Hourly, . . . ) at which data is uploaded to the System for analysis

Care Plan Data Download Refresh rate (202e) (Real-time, Hourly . . . )

Domain Data Synchronization Rate (202e): The rate at which domain data such as Provider Lists, Users, etc are synchronized with the system.

Care Plan Subscription (202a): Partners can also outline which Care Plans they want to subscribe to from a set of Care Plans stored in 182. This information will be stored so the system knows which Care Plans to auto update if changes occur to the base care plans in the system.

Customized Care Plans (202b): Partners can also copy Care Plans and customize them to their own needs and modify certain components of the Care Plan that are not mandatory for that Care Plan

Customized Patient Data Mappings (202c): Allows customers/users to review the standard Data Mappings available for various types of data such as demographic data, Clinical Summary Data and the typical system locations, for that data, and modify them to reflect where this data may come from in their system.

Customized Terminology Mappings (202c): Customers/users can review what terminology sets are available and supported within the system and map user defined items to standard items in the system. This can be applicable and particularly useful to mapping items such as medications or other user defined clinical items that normally map to a code system such as NDC, ICD9, ICD10, LOINC, but in some cases do not.

Operational Workflow: This section outlines the operational flow of Care plans for specific patient's profiles 184 and related tracking of tasks between the system and the Partner System 206.

In a typical workflow when a patient is enrolled in or assigned to a care plan by a user or a rule, and the patient is scheduled for a visit, the Partner System will send an outbound request to the system via the Client Agent (204). This request will retrieve the Care plan that is recommended for this patient based on the rule and complete patient clinical history available at the Server 170. The system will then create a Task Notification 183 for the Relevant Care Team Member or Care Team Group (that was synchronized with the system at install time), in the partner system 206. The system will also link into the Partner system 206 and populate other items such as the care plan itself using the Integration profile information for the particular client. This could include the Care Plan itself in the form of recommendations for Care, Goals, Patient Risk Profile, Patient Education Links, Order sets for different tests to be performed as part of the guidelines. Also depending on the integration profile (202e) and the partner vendor system 206 for that client there may be the ability to send back task completion information from the partner as tasks are completed in the partners system via the Client Agent (204) and sent back to the system in the cloud to reevaluate the Patients Risk score and the progress of the patient through the Care Plan.

The system will also send alerts for tasks that are not completed to the partner system based on the due dates and reminder intervals that exist for the various tasks as the patient progresses through the Care plan.

The invention, in another typical workflow will identify the patient in need of care, by way of a rule 150, and assign that care plan associated with that rule to that patient. The invention then creates the task according to the Integration Profile 202e and transmits 204 and imbeds that task, message or communication into Partner System 206. The user assigned to the care team opens that task in their native workflow as they would any task created by the native system. The task is linked back to the care plan (202a and 202b) and stored in the task manager 182 via the cloud. The care team member reviews the care plan and accepts them into their system using the Customized Patient Data and Terminology Mapping tools (202c and 202d). Utilizing this workflow, a care team member sees a task or message in their normal workflow, opens it and then, with a single click, accepts the care plan into their native systems workflow.

Similarly, if the Patient is linked to the system via a Member Portal 190, the patient will also receive texts, reminders, instructions, referrals, and patient education directly through the Member Portal. Responses from that patient will also be logged against the patient's information and used to reevaluate the patients overall risk score, next steps and actions to be taken.

Actions associated with the Task and information related to the care plan that is received by client agent 204 from partner system 206 will also be logged and trended 185 over time to develop compliance profile for the care team member. As well as for patients and populations they care for to allow for supervisors to be aware of a given Care Team member's performance.

Similarly a patients compliance with medication regimen, Review of Patient Education Material, Reporting of Device Data and Social and clinical values over time will be used to augment or adjust the risk profile and trends for this patient.

By illustration of an example, an aspect of the system will include the ability to react to data collected 110 from cellular and Bluetooth® home monitors such as pulse oximeter's, spirometers, glucose meters and digital scales. A rule, or guideline, can be built 150 to trigger an action for a patient whose clinical information is trending poorly but has not yet contacted a provider or visited with the ER. Using the inventive system, these patients can be identified, their physicians notified as described above to make sure they receive the proper care. Inversely, the same diabetic patient might have gone days/weeks with high blood/sugar levels causing damage to their vascular, renal, extremities and eyes without them knowing. In a sense the system is predicting a future adverse event and acting on the information improve the patient's health and reduce healthcare costs for ER and hospital visits. Adding to the complexity, to properly identify and care for a person with diabetic nephropathy requires validating that the patient's receiving treatment from multiple disparate medical entities. This information must be collected and assembled from insurance companies, laboratories, other EHRs, hospital systems, the patient, pharmacies and the EHR. Once assembled it must be compared to the proper care guideline to insure the patient's compliance with the overall care plan for that disease. The patient has not had a foot within the requisite time period the Care Manager identifies the gap and creates a task in the NextGen EHR. If that provider doesn't act on this information the care manager is notified and can escalate or forward to a different provider. After something like a blood sugar spike is detected multiple parties need to be notified with multiple actions to be taken, and tracked to insure the patient is back on the right path.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A method for collecting data for users of a healthcare system, the method including the steps of:
collecting data from disparate systems for a patient;
reviewing the data;
identifying situations for improved healthcare of the patient; and
reporting the situations for providing improved healthcare to the users.

2. A method as set forth in claim 1 including the step of stratifying risk associated with each of the situations identified.

3. A method for creating a normalized data set, the method comprising the steps of:
collecting data from disparate systems for a patient;
comparing the data against a set of rules;
assigning a risk assessment to the patient based on the data and how it compares to the set of rules; and
creating a trigger when the data exceeds a rule in the set of rules; and
reporting the trigger that was created and the risk assessment.

4. A method as set forth in claim 3 wherein the step of comparing the data includes the step of mapping the data into a normalized data set.

5. A method as set forth in claim 4 including the step of storing the normalized data set in an electronic data warehouse.

6. A method as at forth in claim 5 wherein the step of comparing the data includes the step of identifying the data for different normalized data sets to determine when the data from the disparate systems should be mapped into a unified normalized data set when the data has previously been segregated into different normalized data sets.

7. A method as set forth in claim 6 including the step of storing a complete record of the data from the different normalized data sets and any original source data from each of the disparate systems and what system was used to gather the original source data.

8. A method as set forth in claim 6 including the step of creating a record for each normalized data set.

9. A method as set forth in claim 8 including the step of generating the set of rules using a rules engine.

10. A method as set forth in claim 9 wherein the step of generating the set of rules includes generating each rule in the set of rules from a plurality of different measuring criteria.

11. A method as set forth in claim 3 including the step of generating a task to be performed by a user to facilitate the generation of data to be used to create the normalized data set.

12. A method as set forth in claim 3 including the step of communicating with patients to facilitate the gathering of the data for the creation of the normalized data set.

13. A method as set forth in claim 3 including the step of optimizing costs associate with the gathering of the data for the creation of the normalized data set.

14. A method as set forth in claim 3 including the step of measuring the normalized data set to determine a need of the patient associated with the normalized data set for resources as compared to other of the normalized data sets being generated.

15. A method as set forth in claim 3 wherein the normalized data set is a clinical patient summary.

16. A method as set forth in claim 3 including the step of stratifying the risk assessment to quantify a need for resource allocation.
